(19) United States
(12) Patent Application Publication
(10) Pub. No.: US 2009/0230204 A1
(43) Pub. Date: Sep. 17, 2009

(54) FUEL-POWERED VEHICLE HEATING

(76) Inventors: Michael Pöhner, München (DE); Uwe Strecker, Inning (DE); Markus Griner, Gauting (DE); Andreas Rutsche, München (DE)

Correspondence Address: DICKINSON WRIGHT PLLC, 1875 Eye Street, NW, Suite 1200, WASHINGTON, DC, 20006, US

(21) Appl. No.: 11/720,917

(22) PCT Filed: Nov. 28, 2005
(86) PCT No.: PCT/DE2005/002148

§ 371 Date: Oct. 18, 2007

(30) Foreign Application Priority Data
Dec. 8, 2004 (DE) 10 2004 059 149.0

(51) Int. Cl. B60H 1/22

(52) U.S. Cl. 237/28

(57) ABSTRACT

The invention relates to a fuel-powered vehicle heating (10) with a first burner (12). According to the invention, the vehicle heating comprises at least one second burner (14). By means of the above large power ranges can be covered by several burners with comparatively small heating power steps.

The present invention concerns a fuel-powered vehicle heating system with a first burner. Such vehicle heating systems are used, for example, as parking and/or supplemental heating systems. The fuel used is liquid or gaseous fuel, in particular. Furthermore, the invention can essentially be applied to all types of burners, such as vaporizing burner, atomizing burner, injection or spray burner, etc. Furthermore, the invention can be used for both air and water heating appliances.

A frequent requirement, yet one that is hard to implement, is to provide heating appliances which can modulate the heating power over a very broad range. This is especially due to the fact that burners do not have a variable range of heating performance, but rather have poor useful output values, a reduced lifetime, and an unstable burning behavior above and/or below their optimal working point.

The basic problem of the invention is to specify a fuel-powered vehicle heating system whose heating performance can be modulated over a broad range, without the above mentioned drawbacks occurring.

This problem is solved by the features of claim 1.

Advantageous embodiments and modifications of the invention result from the dependent claims.

The invented fuel-power vehicle heating system is based on the prior art in this field, in that it has at least one second burner. This solution is based on the knowledge that the coupling of two or more burners or heating appliances with rather low heating power stages can cover large power ranges. In this way, it is possible to operate the individual burners or the individual heating appliances at least in the range of their optimal working points. For example, if a large heating power is needed for heating up, then all burners can be started, each with maximum power. If a lower heating power is needed to maintain the heat, it may be sufficient to operate only one burner, for example, in its lowest power stage. Another benefit of the invented solution is that the use of several burners make possible a redundant heating system. A further benefit is that the assortment of models can be advantageously simplified by the invented solution, since the same burner modules can always be used.

Certain embodiments of the invented vehicle heating system call for the first burner and the second burner to be hooked up in parallel in relation to a flow of heat transfer agent. The heat transfer agent can be liquid or gaseous, in particular, such as water or air. It is possible, for example, to incorporate a parallel circuit of two heating appliances or burners into the water circulation system of a motor vehicle, in familiar fashion.

Alternatively, it is possible for the first burner and the second burner to be hooked up in series relative to a flow of heat transfer agent.

Preferred embodiments of the invented vehicle heating system call for operating at least one of the first burner and the second burner with different heating power stages. For example, the combination of two identical heating appliances with two heating power stages of 2 kW and 5 kW produces a vehicle heating system with a total of 5 heating power stages, namely, 2 kW, 4 kW, 5 kW, 7 kW and 10 kW.

In this regard, it is deemed especially advantageous for the different heating power stages to include discrete heating power stages with optimized operating points. An operating point optimization for, say, two heating power stages is technically feasible at reasonable expense, so that better emission levels in particular can be achieved.

It is deemed especially advantageous for the first burner and the second burner to be coordinated with a common regulating or controlling system. In this way, it is possible to have only a single regulating or controlling device overall, which regulates or controls the overall vehicle heating system. Alternatively, the regulating or controlling devices coordinated with the individual burners can have a further regulating or controlling device placed above them, provided in particular for modulating the heating power.

Another advantageous modification of the invented vehicle heating system calls for a modular construction. For example, it is conceivable to combine already present burners or heating appliances into a new vehicle heating system, which could lower the development time and costs as compared to a newly developed burner.

In connection with the above remarks, certain embodiments of the invented vehicle heating system can have the first burner and the second burner being parts of identical modules. However, this does not preclude the use of different burners. For example, one can use two burners, each with only one heating power stage. If, e.g., a burner with 2 kW and a burner with 4 kW is specified, one can adjust the heating power stages at 2 kW, 4 kW, and 6 kW.

In connection with the preferred modularity of the invented vehicle heating system, it can be specified, for example, that it has one or more of the following modules: heat exchange module, module holder, regulating or controlling module, burner module, fuel supply module. The individual modules preferably each have interfaces (mechanical, electrical, hydraulic, etc.) allowing the individual modules to be combined in simple fashion into a vehicle heating system. For example, it is advantageous to design the interfaces of the individual burner modules in such a way that a different number of burner modules are combined in simple manner.

Preferred embodiments of the invention are explained more closely hereafter by means of the drawings, as an example.

These show:

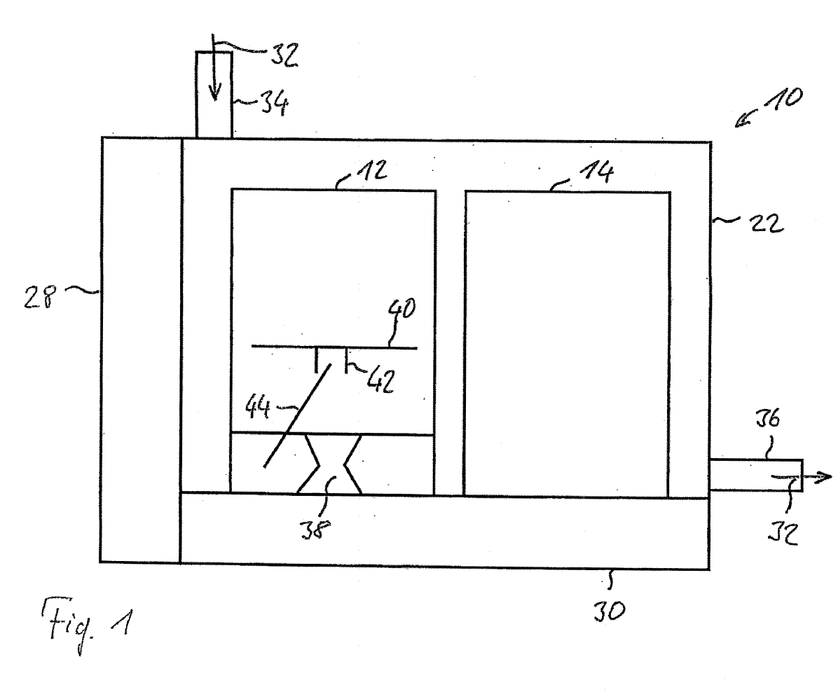

FIG. 1, a schematic block diagram of a first embodiment of the invented vehicle heating system;

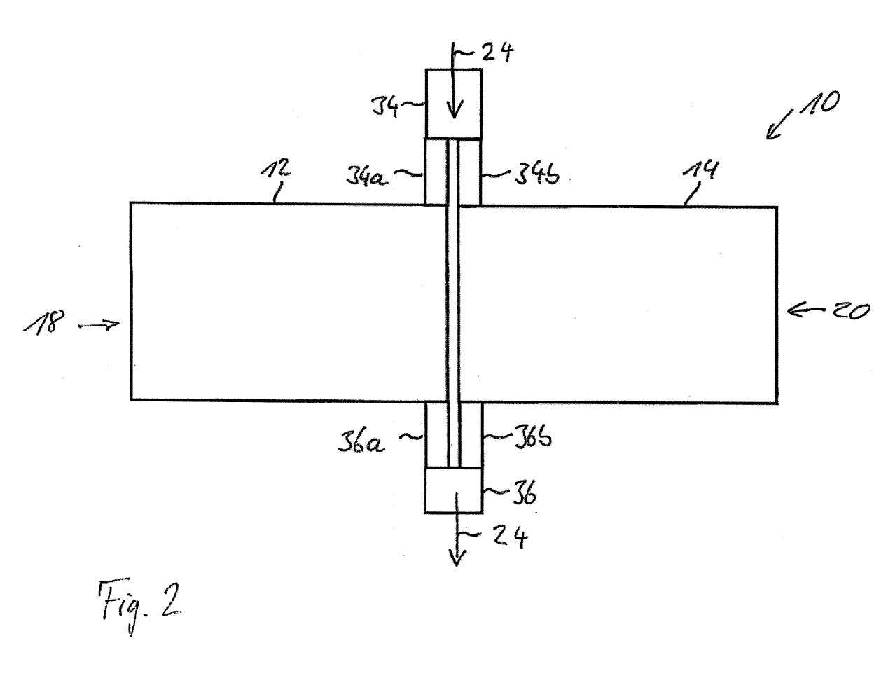

FIG. 2, a schematic block diagram of a second embodiment of the invented vehicle heating system;

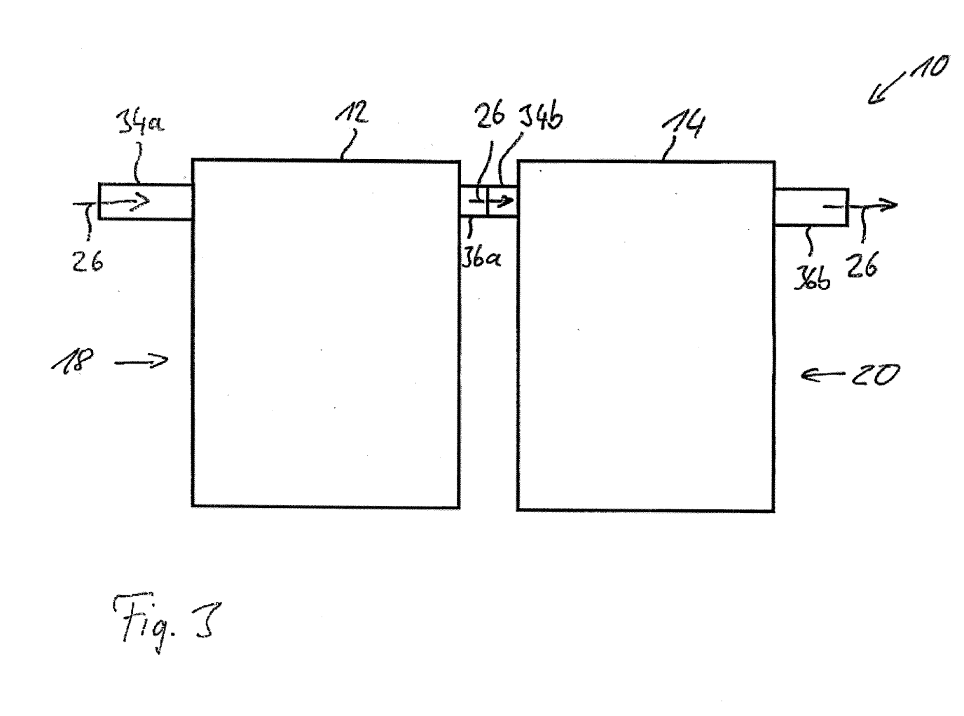

FIG. 3, a schematic block diagram of a third embodiment of the invented vehicle heating system;

In the drawings, the same or similar components are consistently provided with the same or similar reference marks and at least some of their description is not repeated.

FIG. 1 shows schematically a modular vehicle heating system 10. The system 10 shown has a first burner 12 and a second burner 14, being identical in design. The burners 12, 14 can be constructed in familiar manner and have, for example, a fuel feed 38, an igniting device 44, and a baffle 40 with corresponding starting chamber 42, as has been shown for the first burner 12. In the embodiment shown in FIG. 1, a heat exchanger module 22 at the same time constitutes the module holder, to which the other modules of the vehicle heating system are fastened. In addition to the first burner module 12 and the second burner module 14, there is provided in particular in the depicted example a regulating and controlling module 28 and a fuel supply module 30, which can comprise, in particular, pumping equipment, etc. The heating appliance shown in FIG. 1 is incorporated into the water circulation system of the motor vehicle in such a way that the liquid heat transfer agent is supplied via the inlet 34, is heated in the heat exchange module 22, and is taken away via the outlet 36, as is indicated by the flow of heat transfer agent 32.

In the embodiment of the invented vehicle heating system shown in FIG. 2, two burners 12, 14 or two complete heating appliances are arranged in parallel with respect to a flow of heat transfer agent 24. Liquid heat transfer agent is supplied to a common inlet 34 and is then partitioned between the individual inlets 34a, 34b of the first burner 12 and the second burner 14. The liquid heat transfer agent emerging from the respective outlets 36a, 36b of the two heating appliances is combined at a common outlet 36.

One benefit of the parallel connection shown in FIG. 2 is that identical warm heat transfer agent is supplied to both burners 12, 14. Thus, for example, it is possible to design the burners 12, 14 identical, that is, to provide working points optimized to each other.

In the embodiment of the invented vehicle heating system shown in FIG. 3, a first burner 12 and a second burner 14 are hooked up in series with respect to a flow of heat transfer agent 26. In this case as well, the burners 12, 14 can be part of respective smaller heating appliances or they can form an overall modular-design heating appliance.

The liquid heat transfer agent enters at the inlet 34a of the first burner 12, is heated in it if the first burner 12 is active, and leaves the first burner 12 at its outlet 36a, to be supplied via the inlet 34b to the second burner 14. The liquid heat transfer agent exits at the outlet 36b of the second burner 14, in order to be supplied, for example, to a heat exchanger arranged inside the motor vehicle.

The features of the invention disclosed in the foregoing specification, in the drawings and in the claims are essential to the realization of the invention both individually and in any given combination.

### LIST OF REFERENCE MARKS

10 vehicle heating system
12 first burner
14 second burner
16 regulating/controlling system
18 module
20 module
22 module holder
24 flow of heat transfer agent
26 flow of heat transfer agent
28 regulating/controlling module
30 fuel supply module
32 flow of heat transfer agent
34 inlet
34a inlet
34b inlet
36 outlet
36a outlet
36b outlet
38 fuel feed
40 baffle
42 starting chamber
44 igniting device

1. Fuel-powered vehicle heating system q with a first burner, characterized in that it has at least one second burner.

2. Fuel-powered vehicle heating system of claim 1, characterized in that the first burner and the second burner are hooked up in parallel in relation to a flow of heat transfer agent.

3. Fuel-powered vehicle heating system of claim 1, characterized in that the first burner and the second burner are hooked up in series in relation to a flow of heat transfer agent 4.

4. Fuel-powered vehicle heating system of claim 1, characterized in that at least one of the first burner and the second burner can be operated with different heating power stages.

5. Fuel-powered vehicle heating system of claim 4, characterized in that the different heating power stages include discrete heating power stages with optimized operating points.

6. Fuel-powered vehicle heating system of claim 1, characterized in that the first burner and the second burner are coordinated with a common regulating or controlling system.

7. Fuel-powered vehicle heating system of claim 1, characterized in that it has a modular construction.

8. Fuel-powered vehicle heating system of claim 7, characterized in that the first burner/and the second burner are parts of identical modules.

9. Fuel-powered vehicle heating system of claim 7, characterized in that it has one or more of the following modules: heat exchange module, module holder, regulating or controlling module, burner module, fuel supply module.
